(19) United States
(12) Patent Application Publication
(10) Pub. No.: US 2018/0352196 A1
(43) Pub. Date: Dec. 6, 2018

(54) AIRCRAFT DISPLAY SYSTEM HAVING A VIRTUAL WINDOW

(71) Applicant: TE CONNECTIVITY CORPORATION, Berwyn, PA (US)

(72) Inventor: Thierry Emile Henri Marin-Martinod, Oceanside, CA (US)

(21) Appl. No.: 15/613,806

(22) Filed: Jun. 5, 2017

(51) Int. Cl. H04N 7/18; H04N 5/232; G06F 3/14; B64D 11/00

(52) U.S. Cl. CPC H04N 7/181; H04N 5/23293; B64D 2011/0061; B64D 11/00; G06F 3/1423

(57) ABSTRACT

A virtual window for an aircraft includes a frame having panels defining a cavity. The frame is configured to be positioned in an outer wall of the aircraft. The frame has a top, a bottom, a front, a rear, and opposite first and second sides. The front is configured to face a main cabin of the aircraft and the rear configured to face a skin of the aircraft. A display is received in the cavity and includes a screen at the front configured to face the main cabin. A camera is operably coupled to the display and is configured to be positioned in the outer wall and face an exterior of the aircraft. The virtual window includes a power source in the frame being electrically coupled to the display and the camera for powering the display and the camera.

### BACKGROUND OF THE INVENTION

The subject matter herein relates generally to aircraft display systems having virtual windows.

Aircraft include passenger windows along the sides of the aircraft to allow passengers to see outside the aircraft and avoid claustrophobia. However, providing openings in the body of the aircraft is a challenge for aircraft manufacturers and create weaknesses in the structure that may need to be reinforced, which may add weight to the aircraft. The windows need to withstand the high pressures of flight and add cost to the aircraft. The windows and openings create problems with thermal loads in the aircraft. The windows and openings create significant drag on the aircraft, which negatively impacts fuel consumption.

A need remains for an aircraft display system having virtual windows replacing passenger windows of an aircraft.

### BRIEF DESCRIPTION OF THE INVENTION

In one embodiment, a virtual window is provided for an aircraft including a frame having panels defining a cavity. The frame is configured to be positioned in an outer wall of the aircraft. The frame has a top, a bottom, a front, a rear, and opposite first and second sides. The front is configured to face a main cabin of the aircraft and the rear configured to face a skin of the aircraft. A display is received in the cavity and includes a screen at the front configured to face the main cabin. A camera is operably coupled to the display and is configured to be positioned in the outer wall and face an exterior of the aircraft. The virtual window includes a power source in the frame being electrically coupled to the display and the camera for powering the display and the camera.

In another embodiment, a virtual window is provided for an aircraft including a frame having panels defining a cavity. The frame is configured to be positioned in an outer wall of the aircraft. The frame has a top, a bottom, a front, a rear, and opposite first and second sides. The front is configured to face a main cabin of the aircraft and the rear configured to face a skin of the aircraft. A display is received in the cavity and includes a screen at the front configured to face the main cabin. The virtual window includes a power cell in the frame being electrically coupled to the display for powering the display. The power cell has a thermoelectric generator converting temperature differences into electrical energy by a thermoelectric effect. The thermoelectric generator has a first portion being configured to be in thermal communication with the skin of the aircraft and a second portion being configured to be in thermal contact with a component of the aircraft at or near ambient temperature in the main cabin of the aircraft.

In a further embodiment, an aircraft display system for replacing a window in an outer wall of an aircraft is provided including a frame configured to be positioned in the outer wall of the aircraft at a window replacement location for the window between a skin of the aircraft and a main cabin of the aircraft. A display is received in the frame having a screen configured to face the main cabin. A camera is operably coupled to the display and configured to be positioned in the outer wall and face an exterior of the aircraft. A power source is electrically coupled to the display for powering the display. A communication device is operably coupled to the display for controlling the display.

### BRIEF DESCRIPTION OF THE DRAWINGS

FIG. 1 illustrates an aircraft having an aircraft display system formed in accordance with an exemplary embodiment.

FIG. 2 is a cross-sectional view of a portion of the aircraft showing the aircraft display system in accordance with an exemplary embodiment.

FIG. 3 is a rear exploded view of a virtual window of the aircraft display system in accordance with an exemplary embodiment.

FIG. 4 is a front exploded view of the virtual window in accordance with an exemplary embodiment.

FIG. 5 is a schematic view of the aircraft display system in accordance with an exemplary embodiment.

FIG. 6 is a schematic view of the aircraft display system in accordance with an exemplary embodiment.

FIG. 7 is a schematic view of the aircraft display system in accordance with an exemplary embodiment.

### DETAILED DESCRIPTION OF THE INVENTION

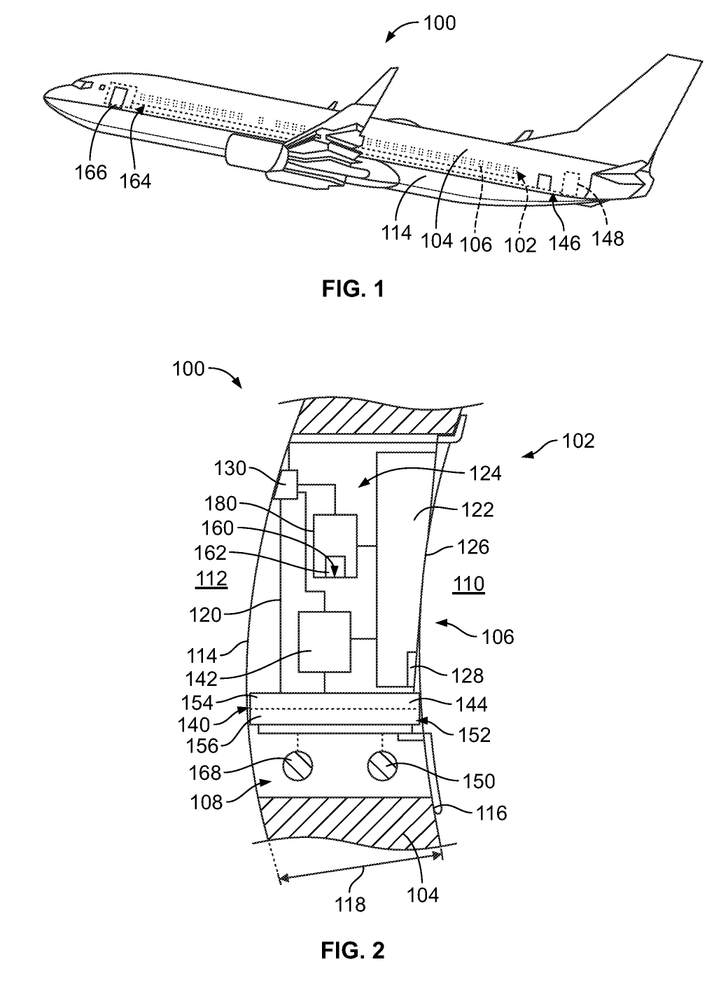

FIG. 1 illustrates an aircraft 100 having an aircraft display system 102 formed in accordance with an exemplary embodiment. FIG. 2 is a cross-sectional view of a portion of the aircraft 100 showing the aircraft display system 102 in accordance with an exemplary embodiment. The aircraft display system 102 is used for replacing passenger windows and an outer wall 104 of the aircraft 100. The aircraft display system 102 includes a plurality of virtual windows 106 replacing passenger windows in the aircraft 100. For example, the aircraft 100 may include one virtual window 106 for each row of passenger seats in the aircraft 100; however, other arrangements of the virtual windows 106 may be utilized in alternative embodiments. The virtual windows 106 are digital windows that display images to the passengers inside the aircraft 100. The virtual windows 106 are received in pockets 108 in the outer wall 104 and face into the passenger cabin of the aircraft 100.

The outer wall 104 of the aircraft 100 defines the fuselage of the aircraft 100. The outer wall 104 separates a main cabin 110 of the aircraft 100 from the exterior environment 112 outside of the aircraft 100. The outer wall 104 includes a skin 114 at the exterior surface of the outer wall 104. The outer wall 104 includes an interior face 116 that faces the main cabin 110. The outer wall 104 has a thickness 118 between the skin 114 and the interior face 116. The virtual window 106 is received in the outer wall 104 within the thickness 118. For example, the virtual window 106 is positioned between the skin 114 and the interior face 116. In an exemplary embodiment, the skin 114 is exterior of the virtual window 106. The virtual window 106 is provided in the aircraft 100 without the need for an opening in the skin 114, such openings and passenger windows of conventional aircraft increasing drag and reducing the structural integrity of the outer wall 104. Utilizing the virtual window 106 illuminates the opening in the skin 114, reducing drag and increasing the structural integrity of the outer wall 104 as compared to conventional aircraft.

With reference to FIG. 2, in an exemplary embodiment, the virtual window 106 includes a frame 120 having a display 122 received in a cavity 124 of the frame 120. The display 122 has a screen 126 that faces the main cabin 110. In an exemplary embodiment, the screen 126 displays an image of the exterior environment 112 as if the passenger were looking through a conventional window in the aircraft 100. The screen 126 may be used to display other images. Optionally, the display 122 may include a user interface 128 4 user control of the display 122 by the passenger seated next to the virtual window 106.

In various embodiments, the virtual window 106 includes a camera 130 operably coupled to the display 122. The camera 130 is configured to be positioned in the outer wall 104 and face the exterior 112 of the aircraft 100. Images from the camera 130 may be displayed on the screen 126. Optionally, the camera 130 may be coupled to the frame 120. Alternatively, the camera 130 may be separate from the frame 120, such as separately mounted to the outer wall 104. In other various embodiments, the camera 130 may be located remote from the frame 120. Optionally, the camera 130 may feed a single display 122. Alternatively, the camera 130 may feed multiple displays 122 of different virtual windows 106.

In various embodiments, the virtual window 106 includes a power source 140 electrically coupled to the display 122 and/or the camera 130 for powering the display 122 and/or the camera 130. The power source 140 may include a battery 142 storing power for the display 122 and/or the camera 130. The power source 140 may include a power cell 144 for generating power to supply the power to the battery 142 and/or the display 122 and/or the camera 130. The power source 140 may include a power network 146 of the aircraft 100. For example, the power network 146 may include a power supply 148 supplying power to one or more of the virtual windows 106 using power cables 150 routed through the outer wall 104.

In an exemplary embodiment, the power cell 144 includes a thermoelectric generator 152 converting temperature differences into electrical energy by a thermoelectric effect. The thermoelectric generator 152 includes a first portion 154 configured to be in thermal communication with the skin 114 of the aircraft 100 and a second portion 156 configured to be in thermal contact with a component of the aircraft 100 at or near ambient temperature in the main cabin 110 of the aircraft 100. For example, the second portion 156 may be in thermal communication with the interior face 116 at or near main cabin ambient temperature. In an exemplary embodiment, the thermoelectric generator 152 is a solid state device that converts heat flux into electrical energy. The first and second portions 154, 156 are dissimilar thermoelectric materials joining at ends. For example, the first portion 154 is an N-type semiconductor (negatively charged) and the second portion 156 is a P-type semiconductor (positively charged). The thermoelectric generator 152 may include multiple N-type semiconductors and multiple P-type semiconductors between the ends. In flight, the skin 114 is typically very cold and the interior face 116 is much warmer than the skin 114 such that the opposite ends of the thermoelectric generator 152 are at different temperatures, thus creating an electric charge used to supply power for the virtual window 106.

In various embodiments, the virtual window 106 includes a communication device 160 operably coupled to the display 122 for controlling the display 122. The communication device 160 may include an antenna 162 for wirelessly receiving display signals. The communication device 160 may include a data network 164 electrically connected to the communication device 160. The data network 164 may be electrically coupled to an aircraft controller 166 configured to send sending control signals for the display on the data network 164, such as along data cables 168. For example, the aircraft controller 166 may be controlled by the flight crew to control the display 122.

In an exemplary embodiment, the virtual window 106 includes a display control unit 180 in the frame 120. The display control unit 180 outputs a display signal to the display 122. The display control unit 180 may be operably coupled to the camera 130, such as receiving an input from the camera 130. The display control unit 180 may be operably coupled to the power source 140. The display control unit 180 may be operably coupled to the communication device 160. For example, the communication device 160 may be integrated with the display control unit 180. For example, the antenna may be electrically coupled to the display control unit 180 and/or the data network 164 may be electrically coupled to the display control unit 180.

In an exemplary embodiment, the display control unit 180 includes a circuit board having a display control circuit for controlling the operation of the virtual window 106. Additionally or alternatively, the aircraft controller 166 may include a display control circuit and/or a display control unit for controlling the operation of the virtual window 106. The display control circuit may include one or more processors. Optionally, the display control circuit may include a central processing unit (CPU), one or more microprocessors, a graphics processing unit (GPU), or any other electronic component capable of processing inputted data according to specific logical instructions. Optionally, the display control circuit may include and/or represent one or more hardware circuits or circuitry that include, are connected with, or that both include and are connected with one or more processors, controllers, and/or other hardware logic-based devices. Additionally or alternatively, the display control circuit may execute instructions stored on a tangible and non-transitory computer readable medium (e.g., the memory).

As used herein, the term “computer,” “subsystem,” “controller circuit,” “circuit,” “control unit” or “module” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “control circuit”.

The computer, subsystem, circuit execute a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer, subsystem, control unit, and/or circuit to perform specific operations such as the methods and processes of the various embodiments. The set of instructions may be in the form of a software program. The software may be in various forms such as system software or application software and which may be embodied as a tangible and non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein. Instead, the use of “configured to” as used herein denotes structural adaptations or characteristics, and denotes structural requirements of any structure, limitation, or element that is described as being “configured to” perform the task or operation. For example, a control unit, circuit, processor, or computer that is “configured to” perform a task or operation may be understood as being particularly structured to perform the task or operation (e.g., having one or more programs or instructions stored thereon or used in conjunction therewith tailored or intended to perform the task or operation, and/or having an arrangement of processing circuitry tailored or intended to perform the task or operation). For the purposes of clarity and the avoidance of doubt, a general purpose computer (which may become “configured to” perform the task or operation if appropriately programmed) is not “configured to” perform a task or operation unless or until specifically programmed or structurally modified to perform the task or operation.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

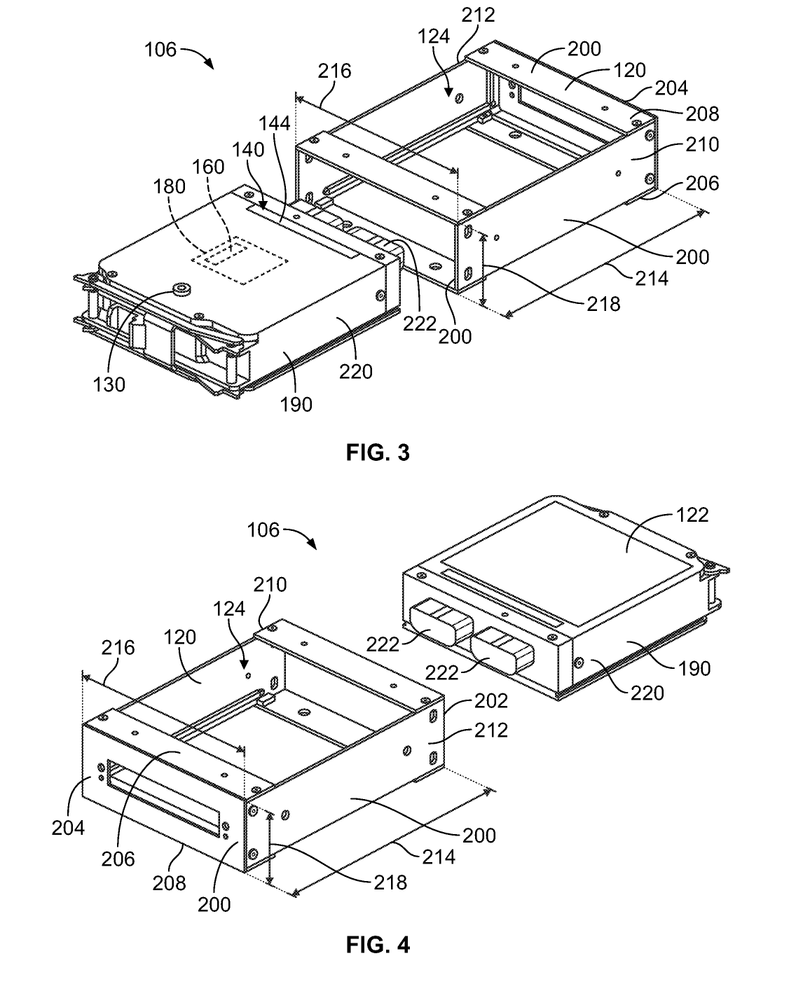

FIG. 3 is a rear exploded view of the virtual window 106 in accordance with an exemplary embodiment. FIG. 4 is a front exploded view of the virtual window 106 in accordance with an exemplary embodiment. In an exemplary embodiment, the virtual window 106 includes a cartridge 190 configured to be received in the cavity 124 of the frame 120. The cartridge 190 includes various components of the virtual window 106 and is configured to be plugged into the frame 120. For example, the frame 120 may be mounted into the outer wall 104 of the aircraft 100 (shown in FIG. 2) and then the cartridge 190 may be removably received in the frame 120. Alternatively, the components of the virtual window 106 may be preassembled in the frame 120 prior to installing the frame 120 into the outer wall 104 of the aircraft 100.

The frame 120 includes a plurality of panels 200 defining the cavity 124. The panels 200 may be sheet metal walls, beams, and the like defining the structure of the frame 120. Optionally, the panels 200 may be assembled into a generally box-shaped structure such that the frame 120 has a top 202, a bottom 204, a front 206, a rear 208 and opposite first and second sides 210, 212. The frame 120 may have other shapes in alternative embodiments including other panels. The panels 200 may be assembled by stamping and forming and/or fastening together. The frame 120 is sized and shaped to be received in the pocket 108 in the outer wall 104. For example, the frame 120 includes a height 214, a width 216 and a depth 218 that are sized and shaped to fit in the pocket 108. Optionally, the height 214 and width 216 are similar dimensions to a conventional passenger aircraft window; however, the height 214 and width 216 may be larger than a conventional passenger aircraft window in various embodiments, such as to provide a larger screen size. The frame 120 is configured to be received in the outer wall 104 such that the rear 208 faces the skin 114 (shown in FIG. 2) and such that the front 206 faces the main cabin 110 (shown in FIG. 2). The frame 120 may be open at the top 202 to receive the cartridge 190. The cartridge 190 may be coupled to the frame 120 when received in the cavity 124. Alternatively, the components of the virtual window 106 may be directly coupled to the frame 120 such as to corresponding panels 200.

In an exemplary embodiment, the cartridge 190 includes an enclosure 220 holding the various components of the virtual window 106. For example, in the illustrated embodiment, the enclosure 220 holds the display 122, the camera 130, the power cell 144, the battery 142 (shown in phantom), the communication device 160 and the display control unit 180. Other components may be held by the cartridge 190. When the cartridge 190 is received in the frame 120, the display 122 is coupled to and supported by the frame 120. The camera 130 is coupled to and supported by the frame 120. The power source 140 is coupled to and supported by the frame 120. The communication device 160 is coupled to and supported by the frame 120. The display control unit 180 is coupled to and supported by the frame 120.

In an exemplary embodiment, the cartridge 190 includes a plurality of connectors 222, such as at the bottom of the enclosure 220. The connectors 222 are configured to be electrically connected to other components, such as the data network 164 and/or the power network 146 (both shown in FIG. 2). For example, the connectors 222 may receive plugs from the data network 164 and/or the power network 146 to supply data and/or power to the virtual window 106.

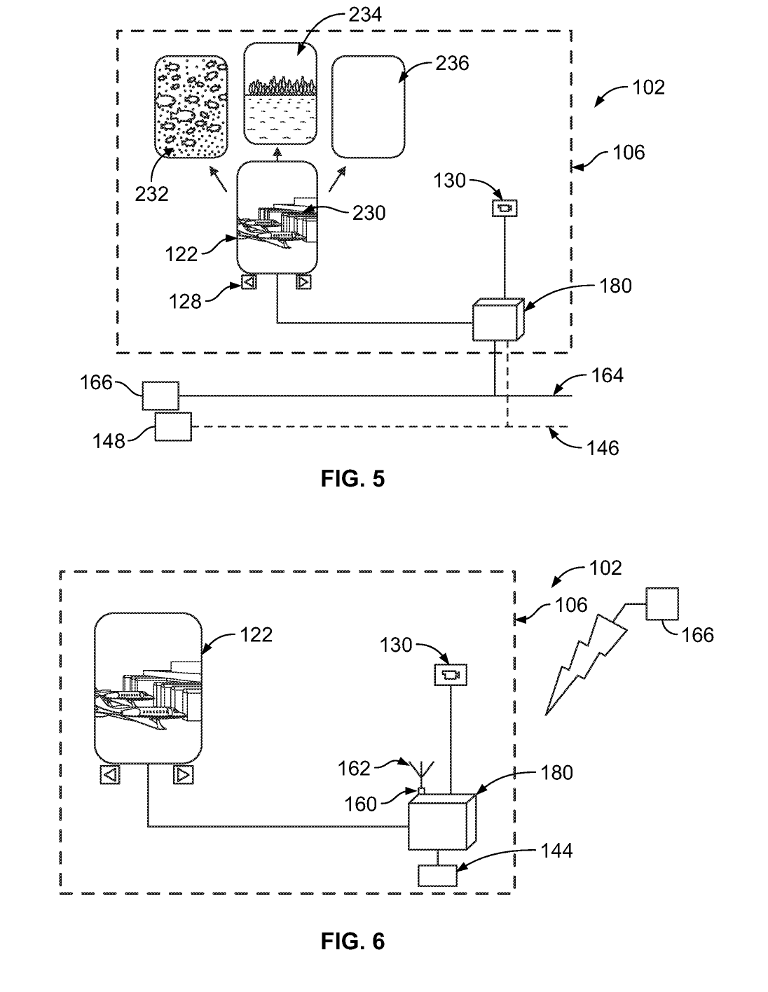

FIG. 5 is a schematic view of the aircraft display system 102 in accordance with an exemplary embodiment. One of the virtual windows 106 is illustrated in FIG. 5 showing the display control unit 180, the camera 130 coupled to the display control unit 180 and the display 122 coupled to the display control unit 180. The display control unit 180 is electrically coupled to the power supply 148 of the aircraft 100 by the power network 146. The display 122 and the camera 130 may be powered by the power supply 148. Optionally, the power supply 148 may supplement power to the virtual window 106, with other power being supplied by the power cell 144 (shown in FIG. 2); however, in various embodiments, the virtual window 106 may be provided without the power cell 144, rather relying on the power supply 148 to supply power to the display 122 and the camera 130.

The display control unit 180 is electrically connected to the aircraft controller 166 by the data network 164. The camera 130 provides video signals to the display control unit 180 and the display 122 may show the images 230 from the camera 130. In an exemplary embodiment, the display 122 may be used to illustrate other images 232, 234, 236. For example, the display 122 may show a movie 232, a commercial or informational movie 234, such as safety instructions during preflight, a dark screen 236 or image to blend in with the interior face 116, or other images. Optionally, the aircraft controller 166 may provide video signals to the display control unit 180 for display by the display 122, such as the preflight safety instructions video. Control of the images at the display 122 may be controlled by the passenger at the user interface 128 and/or from the aircraft controller 166, such as by the flight crew.

FIG. 6 is a schematic view of the aircraft display system 102 in accordance with an exemplary embodiment. One of the virtual windows 106 is illustrated in FIG. 6 showing the display control unit 180, the camera 130 coupled to the display control unit 180, the communication device 160 coupled to the display control unit 180, the power cell 144 coupled to the display control unit 180 and the display 122 coupled to the display control unit 180. The power cell 144 is used to power the display 122 and the camera 130. In the illustrated embodiment, the communication device 160 includes the antenna 162 used to communicate wirelessly with the aircraft controller 166, such as over the aircraft Wi-Fi system. In the illustrated embodiment, the virtual window 106 is a standalone unit that does not need to be hardwired into any other data or power network of the aircraft 100.

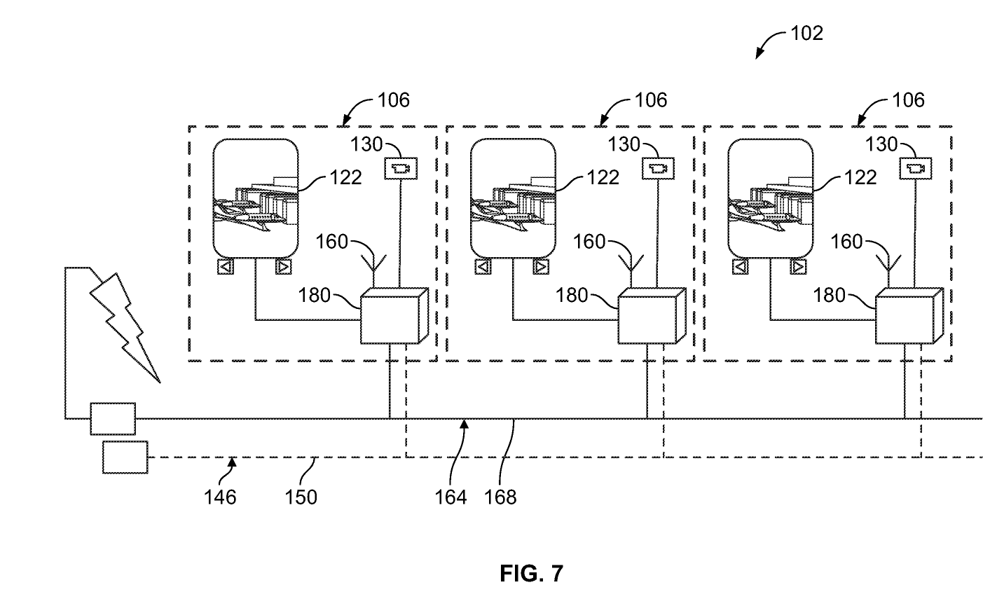

FIG. 7 is a schematic view of the aircraft display system 102 in accordance with an exemplary embodiment. Multiple virtual windows 106 are illustrated in FIG. 7. In the illustrated embodiment, each virtual window 106 includes the camera 130, the communication device 160 and the display 122 coupled to the display control unit 180. Optionally, each screen may display a slightly different image due to the cameras 130 being at different locations along the aircraft 100 (for example, at different rows). In other various embodiments, each camera 130 may be coupled to different display control units 180 to provide the image for the corresponding display control units 180. For example, the images from the camera 130 may be transferred along the data network 164. Optionally, the virtual windows 106 may include the power cells 144 (not shown).

In an exemplary embodiment, each of the display control units 180 of the various virtual windows 106 are electrically coupled to the power network 146 and the data network 164. For example, the three virtual windows 106 illustrated may be provided at different rows of passenger seats along the same outer wall 104 of the aircraft 100. The power cables 150 and data cables 168 may be routed in the outer wall 104 with power takeoffs and data takeoffs to each of the virtual windows 106.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A virtual window for an aircraft comprising:
a frame having panels defining a cavity, the frame being configured to be positioned in an outer wall of the aircraft, the frame having a top, a bottom, a front, a rear, and opposite first and second sides, the front configured to face a main cabin of the aircraft, the rear configured to face a skin of the aircraft;
a display received in the cavity, the display having a screen at the front configured to face the main cabin;
a camera operably coupled to the display, the camera configured to be positioned in the outer wall and facing an exterior of the aircraft;
a power source in the frame being electrically coupled to the display and the camera for powering the display and the camera.

2. The virtual window of claim 1, wherein the camera is coupled to the frame.

3. The virtual window of claim 1, wherein the camera is aligned with the frame at the skin of the aircraft.

4. The virtual window of claim 1, wherein the display displays images of the exterior of the aircraft from the camera.

5. The virtual window of claim 1, wherein the power source includes a battery in the frame supplying power to the display and the camera.

6. The virtual window of claim 1, wherein the power source includes a power cell in the frame being electrically coupled to the display for powering the display, the power cell having a thermoelectric generator converting temperature differences into electrical energy by a thermoelectric effect, the thermoelectric generator having a first portion configured to be in thermal communication with the skin of the aircraft and a second portion configured to be in thermal contact with a component of the aircraft at or near ambient temperature in the main cabin of the aircraft.

7. The virtual window of claim 6, wherein the first portion includes an N-type semiconductor and the second portion includes a P-type semiconductor.

8. The virtual window of claim 1, wherein the power source is electrically coupled to a power network of the aircraft.

9. The virtual window of claim 1, further comprising the communication device operably coupled to the display for controlling the display.

10. The virtual window of claim 9, wherein the communication device is electrically connected to a data network of the aircraft, the data network being operably coupled to an aircraft controller, the aircraft controller sending control signals for the display on the data network.

11. The virtual window of claim 1, wherein the display includes a user interface for controlling the display.

12. The virtual window of claim 1, wherein the frame has a thickness between the front and the rear configured to fit between the skin of the aircraft and an interior face of the outer wall of the aircraft.

13. The virtual window of claim 1, wherein the display is configured to be flush with an interior face of the outer wall of the aircraft.

14. A virtual window for an aircraft comprising:
a frame having panels defining a cavity, the frame being configured to be positioned in an outer wall of the aircraft, the frame having a top, a bottom, a front, a rear, and opposite first and second sides, the front configured to face a main cabin of the aircraft, the rear configured to face a skin of the aircraft;
a display received in the cavity, the display having a screen at the front configured to face the main cabin;
a power cell in the frame being electrically coupled to the display for powering the display, the power cell having a thermoelectric generator converting temperature differences into electrical energy by a thermoelectric effect, the thermoelectric generator having a first portion being configured to be in thermal communication with the skin of the aircraft and a second portion being configured to be in thermal contact with a component of the aircraft at or near ambient temperature in the main cabin of the aircraft.

15. The virtual window of claim 14, wherein the first portion includes an N-type semiconductor and the second portion includes a P type semiconductor.

16. The virtual window of claim 14, wherein the power cell is coupled to a battery received in the cavity of the frame.

17. The virtual window of claim 14, wherein the power cell is coupled to the frame.

18. The virtual window of claim 14, further comprising a camera operably coupled to the display, the camera configured be positioned in the outer wall and facing an exterior of the aircraft, the power cell being electrically coupled to the camera for powering the camera.

19. An aircraft display system for replacing a window in an outer wall of an aircraft, the aircraft display system comprising:
a frame configured to be positioned in the outer wall of the aircraft at a window replacement location for the window between a skin of the aircraft and a main cabin of the aircraft;
a display received in the frame, the display having a screen configured to face the main cabin;
a camera operably coupled to the display, the camera configured to be positioned in the outer wall and facing an exterior of the aircraft;
a power source being electrically coupled to the display for powering the display;
a communication device operably coupled to the display for controlling the display.

20. The aircraft display system of claim 19, wherein the communication device includes an antenna for receiving control signals for the display.

21. The aircraft display system of claim 19, wherein the communication device is electrically connected to a data network of the aircraft, the data network being operably coupled to an aircraft controller, the aircraft controller sending control signals for the display on the data network.

22. The aircraft display system of claim 19, wherein the power source is electrically coupled to a power network of the aircraft.

23. The aircraft display system of claim 19, wherein the power source includes a power cell in the frame being electrically coupled to the display for powering the display, the power cell having a thermoelectric generator converting temperature differences into electrical energy by a thermoelectric effect, the thermoelectric generator having a first portion configured to be in thermal communication with the skin of the aircraft and a second portion configured to be in thermal contact with a component of the aircraft at or near ambient temperature in the main cabin of the aircraft.

24. The aircraft display system of claim 19, further comprising:
a second frame configured to be positioned in the outer wall of the aircraft and a second window replacement location between the skin of the aircraft and the main cabin of the aircraft;
a second display received in the second frame, the second display having a second screen configured to face the main cabin; and
a second communication device being operably coupled to the second display for controlling the second display;
wherein the second display is configured to be operably coupled to at least one of the camera or a second camera; and
wherein the second display is configured to be operably coupled to at least one of the power source or a second power source for powering the second display.
